(19) United States
(12) Patent Application Publication
(10) Pub. No.: US 2026/0245809 A1
(43) Pub. Date: Aug. 20, 2026

(54) SWITCH DEVICE

(71) Applicant: KABUSHIKI KAISHA TOKAI RIKA DENKI SEISAKUSHO, Aichi (JP)

(72) Inventors: Yosuke HATADA, Aichi (JP); Yuta YAMANISHI, Aichi (JP); Masahiro KATO, Aichi (JP); Sota SUZUKI, Aichi (JP)

(73) Assignee: KABUSHIKI KAISHA TOKAI RIKA DENKI SEISAKUSHO, Aichi (JP)

(21) Appl. No.: 19/473,301

(22) PCT Filed: Apr. 5, 2024
(86) PCT No.: PCT/JP2024/014053

§ 371 Date: Oct. 7, 2025

(30) Foreign Application Priority Data
Apr. 10, 2023 (JP) 2023-063548

(51) Int. Cl. H01H 3/08; H01H 15/10; H01H 19/14; H01H 89/00

(52) U.S. Cl. CPC H01H 3/08; H01H 15/102; H01H 19/14; H01H 89/00

(57) ABSTRACT

A knob is turnable about an axis, and is movable along the axis between a first position and a second position. A cam mechanism having a cam face configured to displace a slider in a direction along the axis in accordance with a turning action of the knob. Prescribed positions are provided in a displacement path of the slider A sensor outputs a detection signal indicating that the knob is placed in the first position or the second position. A processor associates the prescribed positions with first controlled states in a case where the detection signal indicates that the knob is placed in the first position. The processor associates the prescribed positions with second controlled states in a case where the signal indicates that the knob is placed in the second position.

### FIELD

The presently disclosed subject matter relates to a switch device for selecting any one of multiple controlled states based on actuation of a knob turnable about an axis.

### BACKGROUND

Japanese Patent Publication No. 2006-216259A discloses a switch device adapted to be installed in a vehicle. The switch device includes a first knob and a second knob each of which is turnable about an axis. As the first knob is turned, a first movable contact provided on the first knob establishes an electrical connection state with any one of multiple first stationary contacts. The multiple electrical connection states established by the first knob are associated with different first controlled states. As the second knob is turned, the second movable contact provided on the second knob establishes an electrical connection state with any one of the multiple second stationary contacts. The multiple electrical connection states established by the second knob are associated with different second controlled states.

### SUMMARY OF THE INVENTION

### Technical Problem

It is required to increase the number of parts that can be shared while maintaining selectability of multiple controlled states.

### Solution to Problem

An illustrative aspect of the presently disclosed subject matter may provide a switch device, comprising:
a knob that is turnable about an axis, and is movable along the axis between a first position and a second position;
a slider;
a cam mechanism having a cam face configured to displace the slider in a direction along the axis in accordance with a turning action of the knob;
a sensor configured to output a signal indicating that the knob is placed in the first position or the second position; and
a processor configured to receive the signal,
wherein prescribed positions are provided in a displacement path of the slider; and
wherein the processor is configured to:
   associate the prescribed positions with first controlled states in a case where the signal indicates that the knob is placed in the first position; and
   associate the prescribed positions with second controlled states in a case where the signal indicates that the knob is placed in the second position.

According to the configuration as described above, it is not necessary to individually provide a knob for selecting one of the first controlled states and a knob for selecting one of the second controlled states. With a simple operation that the common knob is displaced in the direction along the axis to take either the first position or the second position, switching can be realized between the first controlled states and the second controlled states that are to be subjected to the selection performed by the subsequent turning action of the knob. Since the configuration for selecting one controlled state based on the turning action of the knob can be shared with the knob itself, it is possible to increase the number of parts that can be shared while maintaining the selectability of multiple controlled states.

### BRIEF DESCRIPTION OF DRAWINGS

FIG. 1 illustrates an appearance of a switch device according to an exemplary embodiment.

FIG. 2 illustrates an appearance of the switch device of FIG. 1 as viewed from a direction along a turning axis.

FIG. 3 illustrates a state that a knob is removed from the switch device of FIG. 1.

FIG. 4 illustrates a cross section along a line IV-IV of FIG. 2 as viewed from an arrowed direction.

FIG. 5 illustrates an action of the switch device of FIG. 1.

FIG. 6 illustrates an action of the switch device of FIG. 1.

FIG. 7 illustrates an action of the switch device of FIG. 1.

FIG. 8 illustrates an action of the switch device of FIG. 1.

FIG. 9 illustrates an action of the switch device of FIG. 1.

FIG. 10 illustrates a configuration of a controller in the switch device of FIG. 1.

FIG. 11 illustrates another exemplary configuration of the switch device.

### DESCRIPTION OF EMBODIMENTS

Exemplary embodiments will be described in detail below with reference to the accompanying drawings. In each of the drawings, the scale is appropriately changed in order to make each element illustrated have a recognizable size.

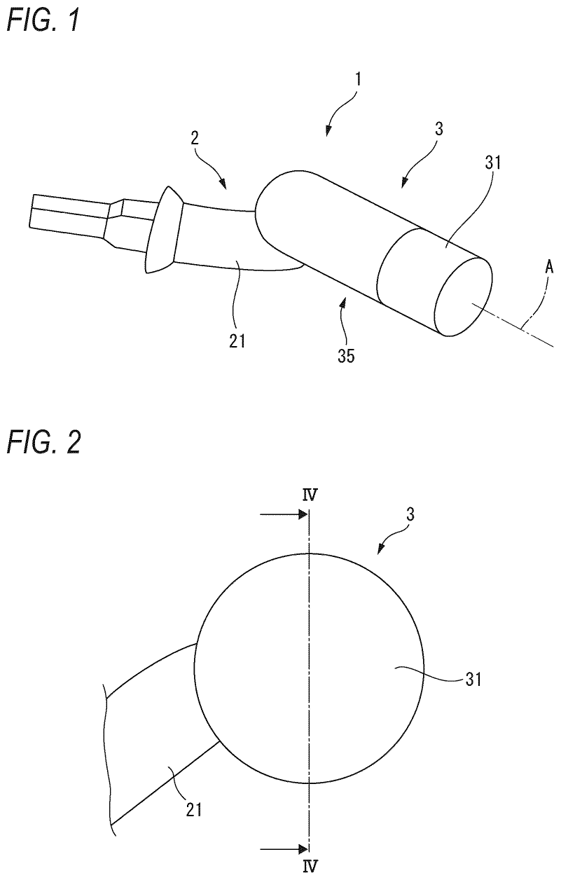

FIG. 1 illustrates an appearance of a switch device 1 according to an exemplary embodiment. The switch device 1 is installed in a vehicle to constitute a part of a steering device for changing a course of the vehicle.

The switch device 1 includes a lever switch 2. The lever switch 2 includes a lever 21 capable of being displaced with respect to the steering device. The lever switch 2 accepts an actuation involving the displacement in order to turn on a direction indicator of the vehicle, for example.

The switch device 1 includes a knob switch 3. The knob switch 3 includes a knob 31 that is turnable about a turning axis A. FIG. 2 illustrates an appearance of the knob switch 3 viewed from a direction along the turning axis A. The knob 31 accepts an actuation involving the turning in order to change, for example, a lighting state of a headlight of the vehicle. The headlight is an example of a device installed in a vehicle. The lighting state is an example of a controlled state.

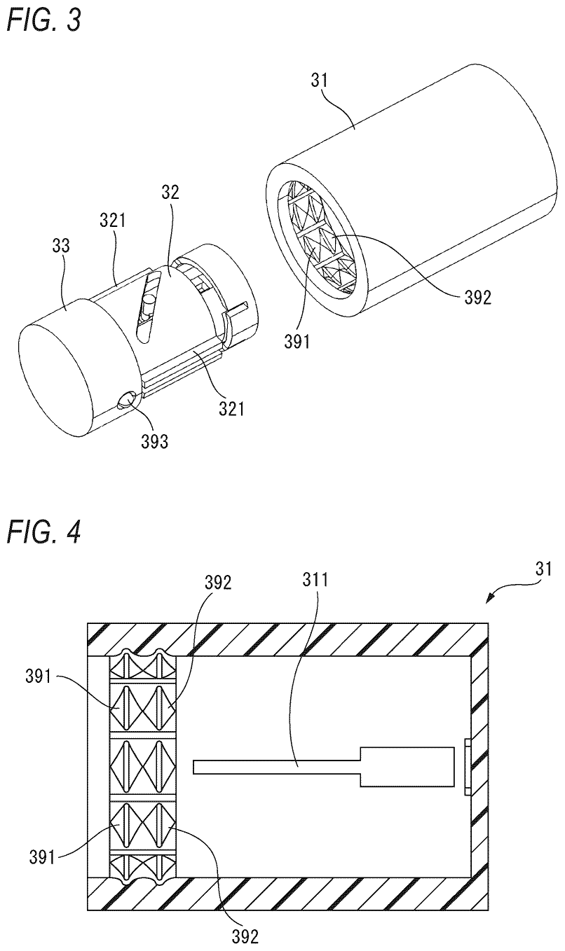

FIG. 3 illustrates an appearance of the knob switch 3 in a state that the knob 31 is removed. The knob switch 3 includes a rotor 32 and a stator 33. The stator 33 is fixed to the lever switch 2. The rotor 32 is supported by a stator 33 so as to be turnable about the turning axis A. An engagement member 321 is provided on an outer circumferential face of the rotor 32.

FIG. 4 illustrates a cross section of the knob 31 viewed from an arrowed direction along the line IV-IV in FIG. 2. An engagement member 311 is provided on an inner circumferential face of the knob 31. As the knob 31 is attached to the rotor 32, the engagement member 311 of the knob 31 engages with the engagement member 321 of the rotor 32. As a result, the rotor 32 is enabled to turn about the turning axis A together with the knob 31. The stator 33 supports the knob 31 by way of the rotor 32. The stator 33 is an example of a support.

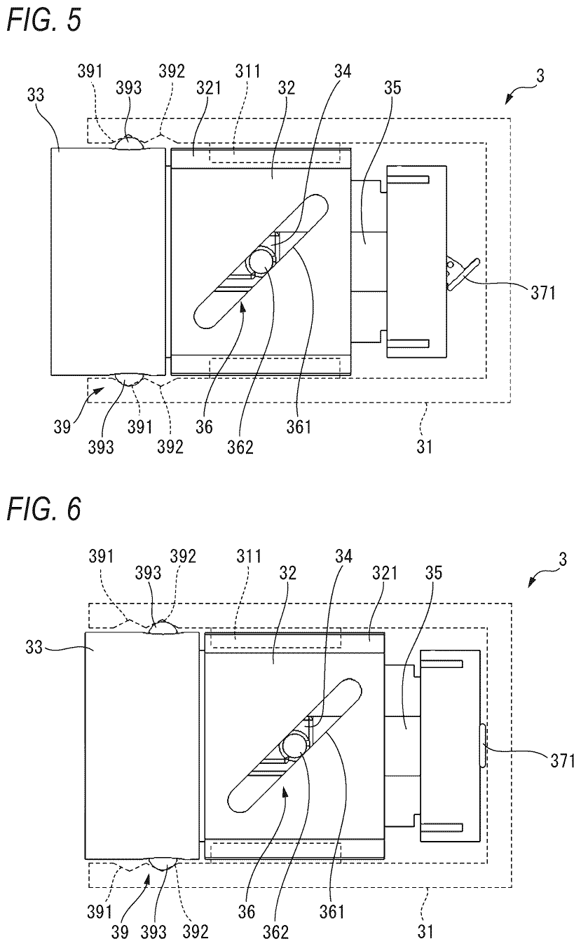

The engagement member 311 and the engagement member 321 both extend in the direction along the turning axis A. As a result, the knob 31 is configured to be slidable in the direction along the turning axis A relative to the rotor 32 and the stator 33. Specifically, the knob 31 is configured to be movable between a first position illustrated in FIG. 5 and a second position illustrated in FIG. 6.

The knob switch 3 includes a slider 34 and a board 35. The board 35 has a shape elongated in a direction along the turning axis A. The slider 34 is mounted on the board 35. Multiple stationary contacts are disposed on the board 35. A movable contact is provided on the slider 34.

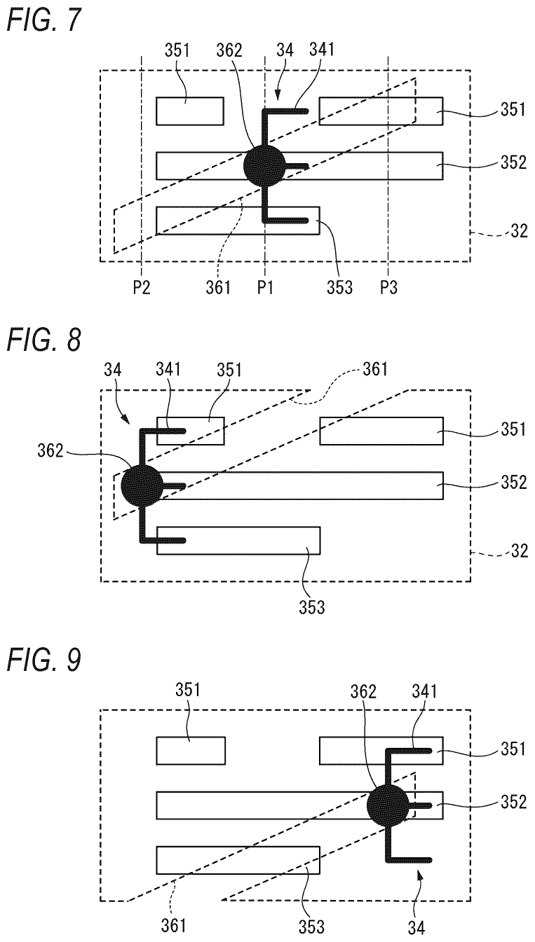

FIG. 7 schematically illustrates a positional relationship between multiple stationary contacts on the board 35 and the movable contact 341 of the slider 34. The multiple stationary contacts include a first contact 351, a second contact 352, and a third contact 353. Each of the first contact 351, the second contact 352, and the third contact 353 is formed of a conductive material and is electrically insulated from each other. Each of the first contact 351, the second contact 352, and the third contact 353 extends in the direction along the turning axis A. The movable contact 341 is formed of a conductive material.

In a first position P1 of the slider 34 illustrated in FIG. 7, the movable contact 341 establishes an electrical connection with the second contact 352 and the third contact 353.

As illustrated in FIG. 5, the knob switch 3 includes a cam mechanism 36. The cam mechanism 36 includes a cam face 361 and a cam follower 362. The cam face 361 is formed as a part of the rotor 32. The cam follower 362 is formed as a part of the slider 34.

The cam face 361 is configured to displace the cam follower 362 in a direction along the turning axis A in accordance with the turning action of the knob 31. In other words, the cam mechanism 36 is configured to displace the slider 34 on the board 35 along the turning axis A in accordance with the turning action of the knob 31.

FIG. 8 illustrates a case where the knob 31 is turned clockwise in FIG. 2 from the state illustrated in FIG. 7. The cam follower 362 is displaced leftward in FIG. 7 along the cam face 361, so that the slider 34 moves to the second position P2 in FIG. 7. In this state, the movable contact 341 establishes electrical connection with the first contact 351, the second contact 352, and the third contact 353.

FIG. 9 illustrates a case where the knob 31 is turned counterclockwise in FIG. 2 from the state illustrated in FIG. 7. The cam follower 362 is displaced rightward in FIG. 9 along the cam face 361, so that the slider 34 moves to the third position P3 in FIG. 7. In this state, the movable contact 341 establishes electrical connection with the first contact 351 and the second contact 352.

In other words, the movable contact 341 establishes different electrical connection states at each of the first position P1, the second position P2, and the third position P3 that are arranged on a displacement path of the slider 34. Each of the first position P1, the second position P2, and the third position P3 is an example of multiple prescribed positions.

The movable contact 341 according to the present example is configured to be electrically connected to at least two stationary contacts regardless of the position of the slider 34. However, depending on the specification of the knob switch 3, the movable contact 341 may be configured to establish an electrical connection with at least one stationary contact.

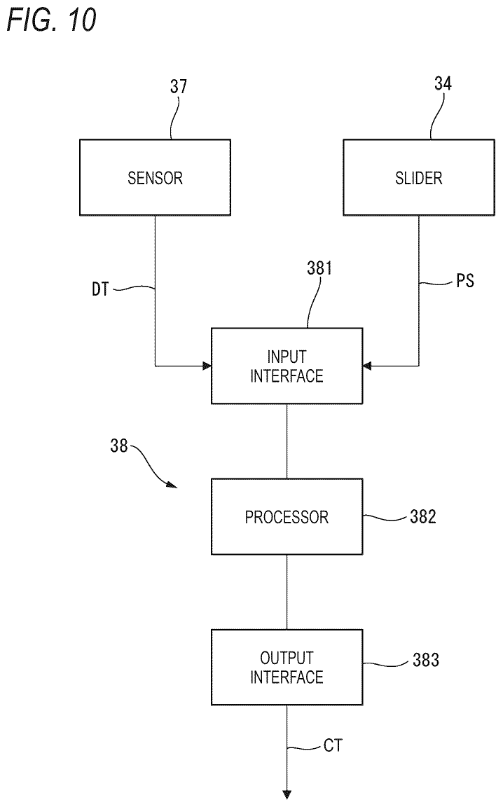

As illustrated in FIG. 10, the knob switch 3 includes a sensor 37 and a controller 38. At least a part of the sensor 37 and the controller 38 are mounted on the board 35. The controller 38 includes an input interface 381, a processor 382, and an output interface 383.

The sensor 37 is configured to output a detection signal DT indicating whether the knob 31 is placed in the first position illustrated in FIG. 5 or the second position illustrated in FIG. 6. The detection signal DT may be an analog signal or a digital signal according to the specification of the sensor 37.

As illustrated in FIGS. 5 and 6, the sensor 37 includes a push switch 371 provided with a part that is mechanically movable. When the knob 31 is placed in the first position, the detection signal DT assumes a first state. As the knob 31 is moved from the first position to the second position, the push switch 371 is pushed by an inner wall face of the knob 31, and the detection signal DT assumes a second state different from the first state. As the knob 31 is moved from the second position to the first position, the depression of the push switch 371 is canceled, so that the detection signal DT returns to the first state.

The position of the knob 31 can be detected by the sensor 37 with an appropriate way as long as the state of the detection signal DT can be changed according to whether the knob 31 is placed in the first position or the second position. For example, the distance between the stator 33 and the inner wall face of the knob 31 can be detected optically or magnetically, so that the state of the detection signal DT can be changed based on the distance.

As illustrated in FIG. 10, the input interface 381 of the controller 38 is configured as a hardware interface for receiving the detection signal DT and a position signal PS. The position signal PS corresponds to an electrical connection state between the contacts that changes in accordance with prescribed positions where the slider 34 can take as described with reference to FIGS. 7 to 9. In a case where at least one of the detection signal DT and the position signal PS is an analog signal, the input interface 381 is provided with an appropriate conversion circuit including an A/D converter.

The processor 382 is configured to associate the multiple prescribed positions related to the slider 34 and indicated by the position signal PS with multiple first controlled states, in a case where the detection signal DT indicates that the knob 31 is placed in the first position. Examples of the multiple first controlled states include multiple operation states in connection with a headlight installed in the vehicle.

The processor 382 is configured to associate the multiple prescribed positions related to the slider 34 and indicated by the position signal PS with multiple second controlled states that are different from the first controlled states, in a case where the detection signal DT indicates that the knob 31 is placed in the second position. Examples of the multiple second controlled states include multiple operation states in connection with a wiper device installed in the vehicle.

The processor 382 is configured to output, from the output interface 383, a control signal CT for realizing one of the first controlled states or one of the second controlled states that is determined in accordance with a combination of the positions of the knob 31 and the slider 34.

In a case where the knob 31 is placed in the first position, the processor 382 outputs a control signal CT, from the output interface 383, for causing the headlight to realize any one of multiple operation states based on a fact that the slider 34 displaced in accordance with the turning actuation of the knob 31 is placed in any one of the positions P1, P2, and P3.

In a case where the knob 31 is placed in the second position, the processor 382 outputs a control signal CT, from the output interface 383, for causing the wiper device to realize any one of multiple operation states based on a fact that the slider 34 displaced in accordance with the turning actuation of the knob 31 is placed in any one of the positions P1, P2, and P3.

The output interface 383 is configured as a hardware interface capable of outputting the operation control signal CT. The control signal CT may be an analog signal or a digital signal according to the specification of the controlled device. In a case where the control signal CT is an analog signal, the output interface 383 is provided with an appropriate conversion circuit including a D/A converter.

According to the configuration as described above, it is not necessary to individually provide a knob for selecting one of the first controlled states and a knob for selecting one of the second controlled states. With a simple operation that the common knob 31 is displaced in the direction along the turning axis A to take either the first position or the second position, switching can be realized between the first controlled states and the second controlled states that are to be subjected to the selection performed by the subsequent turning action of the knob 31. Since the configuration for selecting one controlled state based on the turning action of the knob 31 can be shared with the knob 31 itself, it is possible to increase the number of parts that can be shared while maintaining the selectability of multiple controlled states.

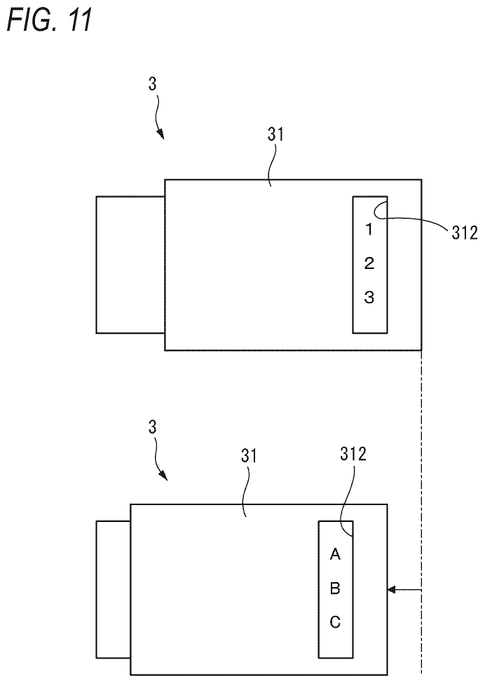

As illustrated in FIG. 11, the knob 31 may be formed with an opening 312. In a case where the knob 31 is placed in the first position, visual confirmation of information indicating multiple controlled states related to the headlight that are selectable with the turning actuation of the knob 31 is made possible through the opening 312. The information may be provided with at least one of characters, figures, symbols, and colors.

In a case where the knob 31 is placed in the second position, visual confirmation of information indicating multiple controlled states related to the wiper device that are selectable with the turning actuation of the knob 31 is made possible through the opening 312. The information may be provided with at least one of characters, figures, symbols, and colors.

The shape and size of the opening 312 are determined such that a peripheral wall of the knob 31 covers the information indicating the controlled states related to the wiper device to disable the visual confirmation of that information when the knob 31 is placed in the first position. Similarly, the shape and size of the opening 312 are determined such that the peripheral wall of the knob 31 covers the information indicating the controlled states related to the headlight to disable the visual confirmation of that information when the knob 31 is placed in the second position.

According to such a configuration, the user can easily recognize the controlled states that can be subjected to the selection with the turning actuation of the knob 31. As a result, it is possible to improve the operability of the switch device 1.

As illustrated in FIG. 5, the knob switch 3 includes a click-feeling generation mechanism 39. The click-feeling generation mechanism 39 includes multiple first recesses 391, multiple second recesses 392, and a pair of protrusions 393.

As illustrated in FIG. 4, the first recesses 391 are provided on an inner circumferential face of the knob 31, and are arranged along the turning direction of the knob 31. The second recesses 392 are provided on the inner circumferential face of the knob 31 and are arranged along the turning direction of the knob 31.

As illustrated in FIGS. 3 and 5, the protrusions 393 are provided on an outer circumferential face of the stator 33. In this example, the protrusions 393 are movable in a direction orthogonal to the turning axis A, and urged toward the inner circumferential face of the knob 31 by an urging member (not illustrated). However, the urging member may be appropriately omitted. In addition, the number of the protrusions 393 may be one or no less than three.

In a case where the knob 31 is placed in the first position illustrated in FIG. 5, each protrusion 393 engages with one of the first recesses 391. In a case where the knob 31 is placed in the second position illustrated in FIG. 6, each protrusion 393 engages with one of the second recesses 392. Since the first recesses 391 and the second recesses 392 are arranged side by side in the direction along the turning axis A, each protrusion 393 is caused to move from one of the first recess and the second recess to the other in response to the displacement of the knob 31 between the first position and the second position. As a result, it is possible to provide a click feeling when a user changes a group of the controlled states that is to be subjected to the selection with the turning action of the knob 31.

Each of the first recesses 391 is associated with one of the controlled states related to the headlight. Accordingly, when the knob 31 placed in the first position is turned, each protrusion 393 is caused to move from one of the first recesses 391 to adjacent one of the first recesses 391. As a result, it is possible to provide a click feeling when the user selects one of the controlled states related to the headlight.

Each of the second recesses 392 is associated with one of the controlled states related to the wiper device. Accordingly, when the knob 31 placed in the second position is turned, each protrusion 393 is caused to move from one of the second recesses 392 to adjacent one of the second recesses 392. As a result, it is possible to provide a click feeling when the user selects one of the controlled states related to the wiper device.

According to the configuration as described above, it is possible to provide the click feeling not only when the group of the controlled states that is to be subjected to the selection performed with the turning action of the knob 31 is changed but also when one of the controlled states in a certain group is selected, without increasing the number of parts.

It should be noted that there may be employed a configuration that at least one protrusion 393 is provided on the inner circumferential face of the knob 31, whereas multiple first recesses 391 and multiple second recesses 392 are provided on the outer circumferential face of the stator 33.

Each configuration described above is merely illustrative in order to facilitate understanding of the presently disclosed subject matter. Each of the above exemplary configurations can be appropriately modified or combined with another exemplary configuration within the teaching of the presently disclosed subject matter.

In the above-described switch device 1, the generation of the position signal PS is performed by establishing any one of multiple electrical connection states between the movable contact 341 provided on the slider 34 and at least one of the stationary contacts provided on the board 35. However, the position of the slider 34 displaced by the cam face 361 of the cam mechanism 36 may be detected optically or magnetically, so that the generation of the position signal PS may be performed based on the position as detected.

The switch device 1 described above constitutes a part of the steering device for changing the traveling direction of the vehicle. The multiple controlled states to be selected based on the turning actuation of the knob 31 correspond to multiple operations to be performed by the headlight installed in the vehicle. However, the multiple controlled states to be selected based on the turning actuation of the knob 31 may be multiple operations to be performed by another device installed in the vehicle. Examples of another device include another lighting device and an opening/closing device for a door or a window.

The switch device 1 described above may not constitute a part of the steering device. The switch device 1 may be disposed at an appropriate position in the vehicle to control the operation of another device installed in the vehicle based on the turning actuation of the knob 31. Examples of another device include an audio-visual device, an air conditioning device, and a navigation device.

The above-described switch device 1 may not be installed in a vehicle. The switch device 1 may be disposed at an appropriate position in a house or a facility to control the operation of various devices disposed in the house or the facility based on the turning actuation of the knob 31.

The present application is based on Japanese Patent Application No. 2023-063548 filed on Apr. 10, 2023, the entire contents of which are incorporated herein by reference.

1. A switch device, comprising:
a knob that is turnable about an axis, and is movable along the axis between a first position and a second position;
a slider;
a cam mechanism having a cam face configured to displace the slider in a direction along the axis in accordance with a turning action of the knob;
a sensor configured to output a signal indicating that the knob is placed in the first position or the second position; and
a processor configured to receive the signal,
wherein prescribed positions are provided in a displacement path of the slider; and
wherein the processor is configured to:
associate the prescribed positions with first controlled states in a case where the signal indicates that the knob is placed in the first position; and
associate the prescribed positions with second controlled states in a case where the signal indicates that the knob is placed in the second position.

2. The switch device according to claim 1,
wherein the knob is formed with an opening;
wherein visual confirmation of information indicating the first controlled states through the opening is enabled in a case where the knob is placed in the first position; and
wherein visual confirmation of information indicating the second controlled states through the opening is enabled in a case where the knob is placed in the second position.

3. The switch device according to claim 1, further comprising:
a support supporting the knob;
a protrusion provided in one of the knob and the support;
first recesses provided in the other of the knob and the support, and arranged in a turning direction of the knob; and
second recesses provided in the other of the knob and the support, and arranged in the turning direction of the knob,
wherein the first recesses are associated with the first controlled states;
wherein the second recesses are associated with the second controlled states;
wherein the protrusion engages with one of the first recesses in accordance with the turning action of the knob, in a case where the knob is placed in the first position; and
wherein the protrusion engages with one of the second recesses in accordance with the turning action of the knob, in a case where the knob is placed in the second position.

4. The switch device according to claim 1,
wherein the slider is provided with a movable conductive contact;
wherein the displacement path is provided with stationary conductive contacts; and
wherein the movable conductive contact is configured to establish one of different electrical connection states with at least one of the stationary conductive contacts at each of the prescribed positions.

5. The switch device according to claim 1,
wherein the switch device constitutes a part of a steering device for changing a traveling direction of a vehicle; and
wherein the first controlled states and the second controlled states correspond to multiple operations performed by at least one device installed in the vehicle.
